(19) United States
(12) Patent Application Publication
(10) Pub. No.: US 2010/0077332 A1
(43) Pub. Date: Mar. 25, 2010

(54) TRANSIENT INDICATION OF RECENTLY-CHANGED OBJECT ELEMENTS

(75) Inventors: Thomas R. Haynes, Apex, NC (US); Lin Sun, Morrisville, NC (US)

Correspondence Address: IBM CORPORATION, 3039 CORNWALLIS RD., DEPT. T81 / B503, PO BOX 12195, RESEARCH TRIANGLE PARK, NC, 27709, US

(73) Assignee: INTERNATIONAL BUISNESS MACHINES CORPORATION, Armonk, NY (US)

(21) Appl. No.: 12/236,780

(22) Filed: Sep. 24, 2008

(51) Int. Cl. G06F 3/048; G06F 17/30

(52) U.S. Cl. 715/765; 707/E17.005

(57) ABSTRACT

An addition of an object or a change to an object is detected within a document. At least one of a time date-stamp or an embellishment of the object is provided, indicative of a relative time at which the change was made to the object. When an embellishment is associated with the object, the object is displayed the object with the embellishment, where the embellishment provides a visual indication of both a location and a change status of the object that was recently changed within the document, relative to a remainder of the document. When a time date-stamp is associated with the object, the object is displayed along with the time date-stamp within the document to provide a visual indication of the time and date at which the change was made to the object relative to a remainder of information within the document.

### BACKGROUND

1. Technical Field

The present invention generally relates to computer systems and in particular to a system and method for providing transient indication of recently changed object elements.

2. Description of the Related Art

Currently, in the field of computer systems, there are many software applications available. Some of these software applications are geared toward a specific, single area or field, while others cover multiple areas. These software applications include word processing applications, graphics applications, and audio applications, for example. Word processing applications enable users to create various types of documents including letters, papers, memos, and books. In the process of creating a document, many changes are typically added. When making changes to a document using a software program such as Microsoft Word®, an author or editor often finds himself skipping around amid the body of the text, adding or modifying words and sentences in various locations of the document. Sometimes it is difficult for the writer to ascertain where in the document he has made the most recent changes, especially when the writer is jumping around the document.

Currently available editing software applications like Microsoft Word commonly have a “changed” edit indication, where alterations made in the current session are shown in a different font characteristic (e.g. color, underlined). However, there is no transient time aspect to this indication. Thus, current software applications only show in a binary way what is different from the last time a document was saved or the last time changes were made permanent.

### SUMMARY OF ILLUSTRATIVE EMBODIMENTS

Disclosed are a method, a system and a computer program product for providing transient indication of recently changed object in a document, via the use of a time date-stamp and color coding. Prior to creating and opening a document, specific preferences are set utilizing a transient indication (TI) utility. First time date-stamp preferences containing a minimum, a maximum, as well as one or more other customizable time date-stamp intervals are set. Then, color preferences including a background color, a foreground color, as well as one or more other customizable color fields are set. Once the document is created and/or opened, the utility triggers activation of a time date-stamp clock. The time date-stamp preferences as well as the color preferences are associated with the newly opened document. The TI utility then uses the time date-stamp and the color preferences to keep track of the changes as the changes are being introduced into the document. The utility (or document) keeps track of each letter, other character, word, or paragraph according to the defined colors and time date-stamp intervals. When the document is saved, all information is committed and all the colored objects are converted to the defined foreground color. When the option to close the document is selected, the current state of the document prior to closing is saved. This option enables the recovery of the document to the state the document was in when invoked the document is opened in the future.

The above as well as additional features and advantages of the present invention will become apparent in the following detailed written description.

### BRIEF DESCRIPTION OF THE DRAWINGS

The invention itself will best be understood by reference to the following detailed description of an illustrative embodiment when read in conjunction with the accompanying drawings, wherein:

FIG. 1 is a block diagram of a data processing system configured with hardware and software components for implementing one or more embodiments of the invention;

FIG. 2 illustrates a system-level figure of an example document with time-date stamp and color metrics to track transient modifications to the document, in accordance with one embodiment of the invention; and

FIG. 3 is a flow chart of the process by which the transient indication features of the invention are implemented, according to one embodiment of the invention.

### DETAILED DESCRIPTION OF AN ILLUSTRATIVE EMBODIMENT

The illustrative embodiments provide a method, system and computer program product for providing transient indication of recently changed object elements in a document, via the use of a time date-stamp and color coding.

In the following detailed description of exemplary embodiments of the invention, specific exemplary embodiments in which the invention may be practiced are described in sufficient detail to enable those skilled in the art to practice the invention, and it is to be understood that other embodiments may be utilized and that logical, architectural, programmatic, mechanical, electrical and other changes may be made without departing from the spirit or scope of the present invention. The following detailed description is, therefore, not to be taken in a limiting sense, and the scope of the present invention is defined only by the appended claims.

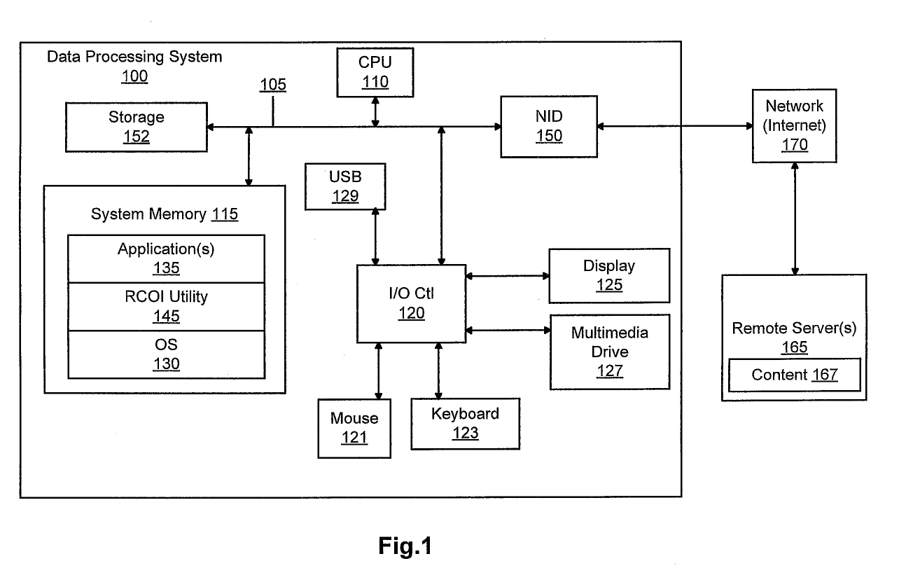

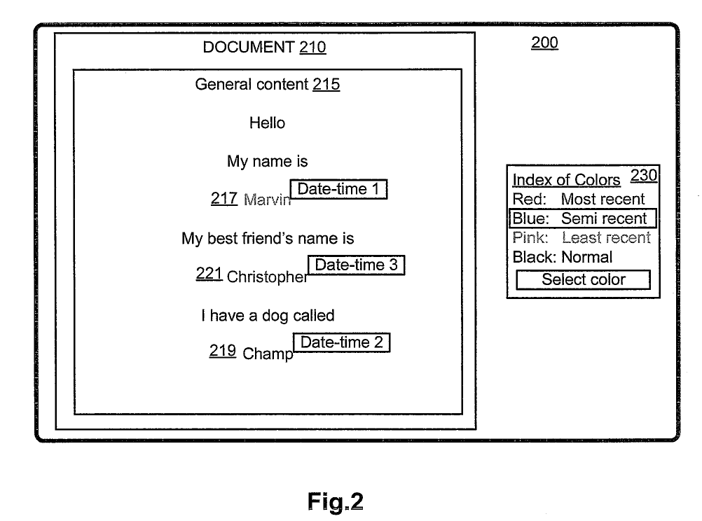

Within the descriptions of the figures, similar elements are provided similar names and reference numerals as those of the previous figure(s). Where a later figure utilizes the element in a different context or with different functionality, the element is provided a different leading numeral representative of the figure number (e.g., 1xx for FIGS. 1 and 2xx for FIG. 2). The specific numerals assigned to the elements are provided solely to aid in the description and not meant to imply any limitations (structural or functional) on the invention.

It is understood that the use of specific component, device and/or parameter names are for example only and not meant to imply any limitations on the invention. The invention may thus be implemented with different nomenclature/terminology utilized to describe the components/devices/parameters herein, without limitation. Each term utilized herein is to be given its broadest interpretation given the context in which that terms is utilized.

Referring now to FIG. 1, which depicts a block diagram representation of a data processing system (with connected network). DPS 100 comprises at least one processor or central processing unit (CPU) 110 connected to system memory 115 via system interconnect/bus 105. System memory 115 is defined as a lowest level of volatile memory (not shown), including, but not limited to, cache memory, registers, and buffers. Also connected to system bus 105 is I/O controller 120, which provides connectivity and control for input devices, of which pointing device (or mouse) 121 and keyboard 123 are illustrated, and output devices, of which display 125 is illustrated. Additionally, a multimedia drive 127 (e.g., CDRW or DVD drive) and USB (universal serial bus) hub 129 are illustrated, coupled to I/O controller. Multimedia drive 127 and USB hub 129 may operate as both input and output (storage) mechanisms. DPS 100 also comprises storage 152, within which data/instructions/code may be stored.

DPS 100 is also illustrated with network interface device (NID) 150 coupled to system bus 110. NID 150 enables DPS 100 to connect to one or more access networks, such as the Internet. In the described embodiments, Internet 170 is a worldwide collection of networks and gateways that utilize the Transmission Control Protocol/Internet Protocol (TCP/IP) suite of protocols to communicate with one another. Of course, network access may also be provided via a number of different types of networks, such as an intranet, a local area network (LAN), a virtual private network (VPN), or other wide area network (WAN) other than the Internet, for example. Those of ordinary skill in the art will appreciate that the hardware depicted in FIG. 1 is a basic illustration of an ISP server, and thus the hardware utilized in actual implementation may vary. Thus, the depicted example is not meant to imply architectural limitations with respect to the present invention.

Notably, in addition to the above described hardware components of DPS 100, various features of the invention are completed via software (or firmware) code or logic stored within system memory 115 or other storage (e.g., storage 152) and executed by CPU 110. In one embodiment, data/instructions/code from storage 152 populates system memory 115, which is also coupled to system bus 105. Thus, illustrated within system memory 115 are a number of software/firmware components, including operating system (OS) 130 (e.g., Microsoft Windows®, a trademark of Microsoft Corp, or GNU®/Linux®, registered trademarks of the Free Software Foundation and The Linux Mark Institute, or Advanced Interactive eXecutive—AIX—, registered trademark of International Business Machines—IBM), document generating applications 135, and transient indication (TI) or recently changed object indication (RCOI) utility 145.

In actual implementation, RCOI utility 145 may be combined or integrated into document generating applications 135 to provide a single application that collectively provides the various functions of each individual software component when the corresponding code is executed by the CPU 110. For simplicity, RCOI utility 145 is illustrated and described as a stand alone or separate software/firmware component, which is stored in system memory 115 to provide/support the specific novel functions described herein. Also, the user interface features of OS 130 may be combined with those of RCOI utility 145, collectively providing the user interface aspects of the invention, when the relevant code is executed by the CPU 110.

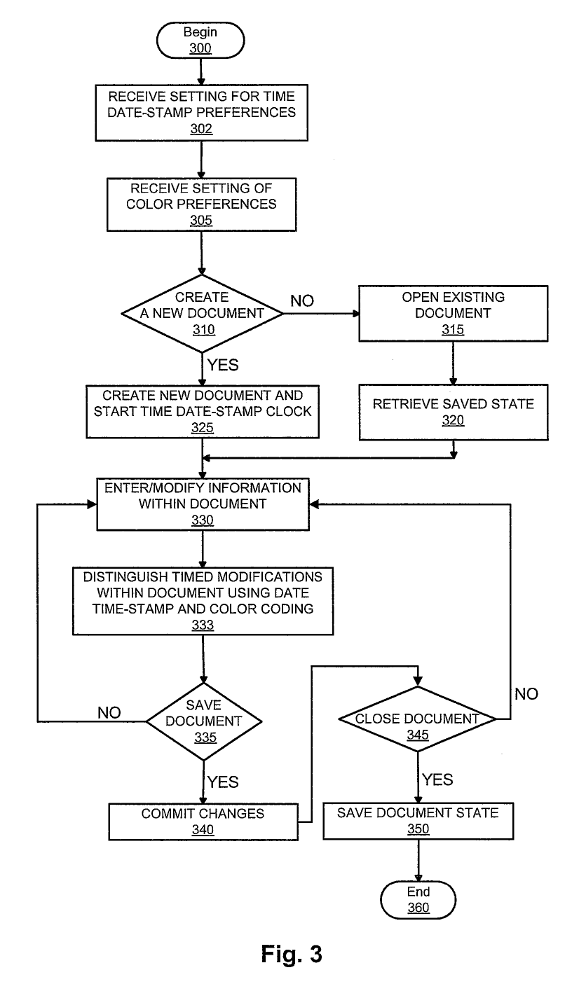

In the illustrative embodiment, RCOI utility 145 generates/provides several graphical user interfaces (GUI) to enable user interaction with, or manipulation of, the functional features of the RCOI utility 145. Among the software code/instructions provided by RCOI utility 145, and which are specific to the invention, are: (a) code for setting time date-stamp, and color preferences (b) code for keeping track of recently-changed objects utilizing one or more of the time date-stamp and the color preferences; and (c) code for saving document state when closing document. For simplicity of the description, the collective body of code that enables these various features is referred to herein as RCOI utility 145. According to the illustrative embodiment, when CPU 110 executes RCOI utility 145, document generating applications 135 initiate a series of functional processes that enable the above functional features as well as additional features/functionality, which are described below within the description of FIGS. 2-3.

Those of ordinary skill in the art will appreciate that the hardware and basic configuration depicted in FIG. 1 may vary. For example, other devices/components may be used in addition to or in place of the hardware depicted. The depicted example is not meant to imply architectural limitations with respect to the present invention. The data processing system depicted in FIG. 1 may be, for example, an IBM eServer pSeries system, a product of International Business Machines Corporation in Armonk, N.Y., running the Advanced Interactive Executive (AIX) operating system or LINUX operating system.

With reference now to FIG. 2, there is illustrated a viewable screen in which a document is opened and is illustrated with recently edited elements highlighted by one or both of a time date-stamp and a color coding, according to embodiments of the invention. Document 210 includes original content, generally indicated by content 215, and recently changed content, indicated by 217, 219, 221, which are numbered in ordered sequence based on the timing of each of the recent changes. That is, content 217 was changed prior to content 219, which was, in turn changed prior to content 221. To differentiate among the different times at which the changes occurred, a time date-stamp is provided above each content 217, 219, 221, according to a first embodiment. Additionally, according to a second embodiment, the ordering of the changes/modifications is further indicated by a color code, with the most recent change provided by a brightest (most visible) color or by a pre-set color. Where preset colors are utilized to indicate the backwards order of changes, a chart of the colors and their relative timing is provided, as illustrated by color-coding insert 230. These colors may be selected (via a selection button) by the user of the application that generates the document 210, in one embodiment. Notably, FIG. 2 provides a single example of the application of the features of the invention, and is not intended to provide any limitation on the general applicability of the features and functionality of the present invention.

FIG. 3 is a flow chart illustrating the method by which the process of the illustrative embodiment is completed. Although the method illustrated in FIG. 3 may be described with reference to components shown in FIGS. 1 and 2, it should be understood that this is merely for convenience and alternative components and/or configurations thereof can be employed when implementing the various methods. Key portions of the methods may be completed by RCOI utility 145 executing within DPS 100 (FIG. 1) and controlling specific operations of a document generating application that is running on DPS 100, and the methods are thus described from the perspective of either/both RCOI utility 145 and DPS 100.

The process of the illustrated embodiment in FIG. 3 begins at initiator block 300 and proceeds to block 302, at which RCOI utility receives input for setting the time date-stamp (or color coding) preferences within a user interface. These preferences may include a minimum and a maximum time interval thresholds. The time interval threshold is then utilized to identify the sequence of the changes made to objects of the document. For example, a one minute time interval, a larger number of minutes time interval, or several days time interval may be utilized. Depending on the level of demarcation desired or proscribed by the utility, there may be a large number of possible settings for the time interval thresholds.

Next, at block 305 the color preferences are received by the utility and set. The color preferences include a background, and foreground colors, which are different from the background color to avoid merging of the objects into the background. For example, a black object on a black background will cause the display to show what appears as simply a black screen. Thus, depending on the background color selected, a series of colors can be defined. These colors can be selected and used in conjunction with the time date-stamp, defined at block 302. Also, a single color of different shade or hue may be utilized to identify the differences in the times of modification for the multiple objects. For example, if the defined foreground color is white, and the new or changed objects color is bright red for a most recent change. Then, depending on the defined time date-stamp interval, as a new interval of time is stated, the new/changed objects can be shown in a brighter or darker shade of the color red than a previously changed object (shown in a lighter shade of red).

Once the time date-stamp and the color preferences are set, a determination is made at block 310 whether the preferences are to be applied to a new document, indicating that a new document is to be created. If the received preferences are to be applied to an existing document, then the existing document is opened at block 315, and the utility retrieves the previously saved state for that existing document at block 320. The previously saved state of the document includes all previously set time date-stamp and color preferences. The document also contains all data or information pertaining to the changes received/made at different time date-stamps, which can be enabled if desired.

If the document does not exist, then the document is created and the time date-stamp is started, at block 325. Next, new changes may be introduced to either the new created document or the existing document at block 330. The recent changes to the document are then kept track of according to the time date-stamp preferences defined at block 302 and the color preferences defined at block 305, and these modifications are identified within the document, as indicated at block 333. If it is determined at decision block 335 that a request to save the document is received, then the recent changes are committed at block 340. The recently changed objects all use the foreground color when committed. Finally when the document is closed, as determined at block 345, then the recent changes are similarly committed, and the state of the document, including time date-stamp preferences, color preferences, as well as the recently changed objects are saved at block 350. The next time that the document is invoked, the saved state is restored. The changes to objects at any time date-stamp can be easily found and highlighted with saved color preferences. The process complete at block 360. It is appreciated that the above example illustrates only some of the possible implementation choices and should not be construed as a limitation of the scope of the present invention which is defined only by the appended claims and their equivalents.

In the flow chart above, one or more of the methods are embodied in a computer readable medium containing computer readable code such that a series of steps are performed when the computer readable code is executed on a computing device. In some implementations, certain steps of the methods are combined, performed simultaneously or in a different order, or perhaps omitted, without deviating from the spirit and scope of the invention. Thus, while the method steps are described and illustrated in a particular sequence, use of a specific sequence of steps is not meant to imply any limitations on the invention. Changes may be made with regards to the sequence of steps without departing from the spirit or scope of the present invention. Use of a particular sequence is therefore, not to be taken in a limiting sense, and the scope of the present invention is defined only by the appended claims.

The above described embodiments provide a method for tracking changes within a document. The method comprises: detecting one of an addition of an object or a change to an object within the document; associating at least one of a time date-stamp and an embellishment of the object, indicative of a relative time at which the change was made to the object, wherein, when the embellishment is a pre-specified color, the pre-specified color is different from a standard color of other information within the document; when an embellishment is associated with the object, displaying the object with the embellishment, wherein the embellishment provides a visual indication of both a location and a change status of the object that was recently changed within the document, relative to a remainder of the information within the document; and when a time date-stamp is associated with the object, displaying the object along with the time date-stamp within the document to provide a visual indication of the time and date at which the change was made to the object relative to a remainder of information within the document.

The method further comprises receiving a setting of one or more time date-stamp preferences; receiving a setting of one or more color preferences, including a selection of at least a first color that indicates a most recently changed status; and when a request is received to create a new document, generating the new document with the respective settings of the time date-stamp preferences and the color preferences as functional parameters for tracking modifications made to information within the document.

To enable tracking of the time date-stamp, the method provides: starting a time date-stamp tracking mechanism when the new document is generated; and re-activating the time date-stamp tracking mechanism when an existing document is re-opened. The tracking mechanism provides a current time-date stamp when the change to the object is detected.

In one embodiment, the method further comprises: receiving one of an entry of new information or a modification of existing information as the object that is being changed within the new or existing document; and tagging the object with a current value of the time date-stamp, when time date-stamp preferences are set for tracking changes within the document.

With one embodiment of the color-coded implementation, the associating of a pre-specified color further comprises: enabling selection within a color-coded insert of which first color represents a most recently changed object and which second color represents a less recently changed object; receiving a selection of at least a second color that indicates a less recently change status; displaying the object with a color from among multiple colors within a color code established by the one or more color preferences; and modifying the color associated with the object when a next object is changed or added to the document to become a most recently changed object, wherein the first pre-specified color is associated with a most recently changed object and the second color is associated with the object that was previously the most recently changed object.

Also, the method provides: in response to saving changes to the document, including the time date-stamp and the color code associated with the changes to the object in a saved version of the document; in response to closing the document after recording one or more changes to objects within the document, including the time date-stamp and the color code associated with the changes in the saved version of the document; and subsequently re-opening and displaying a last saved version of the document with previous changes indicated via the time date-stamp and the color code, respectively indicating when the previous changes were made and which changes were most recent.

According to an alternative embodiment, the method, system and computer program product for providing transient indication of recently changed object elements through the use of a time date-stamp may be enhanced by applying further embellishments other than color preferences. For example, brightness levels, bold/underlined/italics, and font size. All these embellishments used selectively can make the contrast between changes at different time date-stamp intervals more obvious and easy to navigate through.

According to another alternative embodiment, the method, system and computer program product for providing transient indication of recently changed object elements through the use of a time date-stamp may be implemented by speech/audio applications. In the speech/audio applications where a snippet of sound is the object rather than a character, specific speech/audio preferences would need to be defined and set prior creating a speech/audio file. For example, a number of easily detected buzzing or humming background sounds may be defined. Once the speech/audio preferences are set, keeping track of recently-changed speech/audio objects is easily achieved as was the case of a text document.

According to an alternative embodiment, the method, system and computer program product for providing transient indication of recently changed object elements through the use of a time date-stamp may be implemented by drawing applications. Drawing applications include various defined shape objects, and tools to draw non available shapes. Besides color preferences, specific drawing preferences may be defined, and set to differentiate between the different objects. Once the drawing preferences are set, keeping track of recently-changed drawing objects is easily achieved as was the case of a text document.

According to an alternative embodiment, the method, system and computer program product for providing transient indication of recently changed object elements through the use of a time date-stamp may be implemented by website order forms applications. The website order forms application that are text based will be handled similar to text documents. In case where the website order forms are not text based, specific field preferences may need to be defined to identify all the available fields. Once these field preferences are defined and set, keeping track of recently-changed field objects is easily achieved as was the case of a text document.

As will be further appreciated, the processes in embodiments of the present invention may be implemented using any combination of software, firmware or hardware. As a preparatory step to practicing the invention in software, the programming code (whether software or firmware) will typically be stored in one or more machine readable storage mediums such as fixed (hard) drives, diskettes, optical disks, magnetic tape, semiconductor memories such as ROMs, PROMs, etc., thereby making an article of manufacture in accordance with the invention. The article of manufacture containing the programming code is used by either executing the code directly from the storage device, by copying the code from the storage device into another storage device such as a hard disk, RAM, etc., or by transmitting the code for remote execution using transmission type media such as digital and analog communication links. The methods of the invention may be practiced by combining one or more machine-readable storage devices containing the code according to the present invention with appropriate processing hardware to execute the code contained therein. An apparatus for practicing the invention could be one or more processing devices and storage systems containing or having network access to program(s) coded in accordance with the invention.

Thus, it is important that while an illustrative embodiment of the present invention is described in the context of a fully functional computer (server) system with installed (or executed) software, those skilled in the art will appreciate that the software aspects of an illustrative embodiment of the present invention are capable of being distributed as a program product in a variety of forms, and that an illustrative embodiment of the present invention applies equally regardless of the particular type of media used to actually carry out the distribution. By way of example, a non exclusive list of types of media includes recordable type (tangible) media such as floppy disks, thumb drives, hard disk drives, CD ROMs, DVDs, and transmission type media such as digital and analogue communication links.

While the invention has been described with reference to exemplary embodiments, it will be understood by those skilled in the art that various changes may be made and equivalents may be substituted for elements thereof without departing from the scope of the invention. In addition, many modifications may be made to adapt a particular system, device or component thereof to the teachings of the invention without departing from the essential scope thereof. Therefore, it is intended that the invention not be limited to the particular embodiments disclosed for carrying out this invention, but that the invention will include all embodiments falling within the scope of the appended claims. Moreover, the use of the terms first, second, etc. do not denote any order or importance, but rather the terms first, second, etc. are used to distinguish one element from another.

What is claimed is:

1. A method for tracking changes within a document, the method comprising:
detecting one of an addition of an object or a change to an object within the document;
associating at least one of a time date-stamp and an embellishment of the object, indicative of a relative time at which the change was made to the object, wherein, when the embellishment is a pre-specified color, the pre-specified color is different from a standard color of other information within the document;
when an embellishment is associated with the object, displaying the object with the embellishment, wherein the embellishment provides a visual indication of both a location and a change status of the object that was recently changed within the document, relative to a remainder of the information within the document; and
when a time date-stamp is associated with the object, displaying the object along with the time date-stamp within the document to provide a visual indication of the time and date at which the change was made to the object relative to a remainder of information within the document.

2. The method of claim 1, further comprising:
receiving a setting of one or more time date-stamp preferences;
receiving a setting of one or more embellishment preferences, including a selection of at least a first embellishment that indicates a most recently changed status; and
when a request is received to create a new document, generating the new document with the respective settings of the time date-stamp preferences and the embellishment preferences as functional parameters for tracking modifications made to information within the document.

3. The method of claim 2, further comprising:
starting a time date-stamp tracking mechanism when the new document is generated; and
re-activating the time date-stamp tracking mechanism when an existing document is re-opened; and
wherein the tracking mechanism provides a current time-date stamp when the change to the object is detected.

4. The method of claim 2, further comprising:
receiving one of an entry of new information or a modification of existing information as the object that is being changed within the new or existing document; and
tagging the object with a current value of the time date-stamp, when time date-stamp preferences are set for tracking changes within the document.

5. The method of claim 1, wherein the associating of a pre-specified color further comprises:
enabling selection within a color-coded insert of which first color represents a most recently changed object and which second color represents a less recently changed object;
receiving a setting of one or more color preferences, including a selection of at least a first color that indicates a most recently changed status;
receiving a selection of at least a second color that indicates a less recently change status;
displaying the object with a color from among multiple colors within a color code established by the one or more color preferences; and
modifying the color associated with the object when a next object is changed or added to the document to become a most recently changed object, wherein the first pre-specified color is associated with a most recently changed object and the second color is associated with the object that was previously the most recently changed object.

6. The method of claim 1, further comprising:
in response to saving changes to the document, including the time date-stamp and the color code associated with the changes to the object in a saved version of the document;
in response to closing the document after recording one or more changes to objects within the document, including the time date-stamp and the color code associated with the changes in the saved version of the document; and
subsequently re-opening and displaying a last saved version of the document with previous changes indicated via the time date-stamp and the color code, respectively indicating when the previous changes were made and which changes were most recent.

7. The method of claim 1, further comprising:
when said new document is a speech/audio file, receiving a setting of speech/audio preferences;
when said new document is a drawing document, receiving a setting of drawing preferences; and
when said new document is an online order form, receiving a setting of entry field preferences.

8. A computer program product comprising:
a computer readable medium; and
program code on the computer readable medium that when executed by a processor causes a computer device to perform the functions of:
detecting one of an addition of an object or a change to an object within the document;
associating at least one of a time date-stamp and an embellishment of the object, indicative of a relative time at which the change was made to the object, wherein, when the embellishment is a pre-specified color, the pre-specified color is different from a standard color of other information within the document;
when an embellishment is associated with the object, displaying the object with the embellishment, wherein the embellishment provides a visual indication of both a location and a change status of the object that was recently changed within the document, relative to a remainder of the information within the document; and
when a time date-stamp is associated with the object, displaying the object along with the time date-stamp within the document to provide a visual indication of the time and date at which the change was made to the object relative to a remainder of information within the document.

9. The computer program product of claim 8, further comprising program code for:
receiving a setting of one or more time date-stamp preferences;
receiving a setting of one or more embellishment preferences, including a selection of at least a first embellishment that indicates a most recently changed status; and
when a request is received to create a new document, generating the new document with the respective settings of the time date-stamp preferences and the embellishment preferences as functional parameters for tracking modifications made to information within the document.

10. The computer program product of claim 9, further comprising program code for:
starting a time date-stamp tracking mechanism when the new document is generated; and
re-activating the time date-stamp tracking mechanism when an existing document is re-opened; and
wherein the tracking mechanism provides a current time-date stamp when the change to the object is detected.

11. The computer program product of claim 9, further comprising program code for:
receiving one of an entry of new information or a modification of existing information as the object that is being changed within the new or existing document; and
tagging the object with a current value of the time date-stamp, when time date-stamp preferences are set for tracking changes within the document.

12. The computer program product of claim 8, wherein the program code for associating of a pre-specified color further comprises code for:
enabling selection within a color-coded insert of which first color represents a most recently changed object and which second color represents a less recently changed object;
receiving a setting of one or more color preferences, including a selection of at least a first color that indicates a most recently changed status;
receiving a selection of at least a second color that indicates a less recently change status;
displaying the object with a color from among multiple colors within a color code established by the one or more color preferences; and
modifying the color associated with the object when a next object is changed or added to the document to become a most recently changed object, wherein the first pre-specified color is associated with a most recently changed object and the second color is associated with the object that was previously the most recently changed object.

13. The computer program product of claim 8, further comprising program code for:
in response to saving changes to the document, including the time date-stamp and the color code associated with the changes to the object in a saved version of the document;
in response to closing the document after recording one or more changes to objects within the document, including the time date-stamp and the color code associated with the changes in the saved version of the document; and
subsequently re-opening and displaying a last saved version of the document with previous changes indicated via the time date-stamp and the color code, respectively indicating when the previous changes were made and which changes were most recent.

14. The computer program product of claim 8, further comprising program code for:
when said new document is a speech/audio file, receiving a setting of speech/audio preferences;
when said new document is a drawing document, receiving a setting of drawing preferences; and
when said new document is an online order form, receiving a setting of entry field preferences.

15. A computer device comprising:
a processor; and
an application executing on the processor and which generates one or more documents with content that is changeable;
a utility having program instructions that when executed by the processor along with the application causes the computer device to provide the functions of:
detecting one of an addition of an object or a change to an object within the document;
associating at least one of a time date-stamp and an embellishment of the object, indicative of a relative time at which the change was made to the object, wherein, when the embellishment is a pre-specified color, the pre-specified color is different from a standard color of other information within the document;
when an embellishment is associated with the object, displaying the object with the embellishment, wherein the embellishment provides a visual indication of both a location and a change status of the object that was recently changed within the document, relative to a remainder of the information within the document; and
when a time date-stamp is associated with the object, displaying the object along with the time date-stamp within the document to provide a visual indication of the time and date at which the change was made to the object relative to a remainder of information within the document.

16. The computer device of claim 15, wherein the utility further comprises program instructions for:
receiving a setting of one or more time date-stamp preferences;
receiving a setting of one or more embellishment preferences, including a selection of at least a first embellishment that indicates a most recently changed status;
when a request is received to create a new document, generating the new document with the respective settings of the time date-stamp preferences and the embellishment preferences as functional parameters for tracking modifications made to information within the document;
when said new document is a speech/audio file, receiving a setting of speech/audio preferences;
when said new document is a drawing document, receiving a setting of drawing preferences; and
when said new document is an online order form, receiving a setting of entry field preferences.

17. The computer device of claim 16, said utility further comprising program instructions for:
starting a time date-stamp tracking mechanism when the new document is generated;
re-activating the time date-stamp tracking mechanism when an existing document is re-opened;
wherein the tracking mechanism provides a current time-date stamp when the change to the object is detected.
receiving one of an entry of new information or a modification of existing information as the object that is being changed within the new or existing document; and
tagging the object with a current value of the time date-stamp, when time date-stamp preferences are set for tracking changes within the document.

18. The computer device of claim 15, wherein the program instructions for associating of a pre-specified color further comprises code for:
enabling selection within a color-coded insert of which first color represents a most recently changed object and which second color represents a less recently changed object;
receiving a setting of one or more color preferences, including a selection of at least a first color that indicates a most recently changed status;
receiving a selection of at least a second color that indicates a less recently change status;
displaying the object with a color from among multiple colors within a color code established by the one or more color preferences; and
modifying the color associated with the object when a next object is changed or added to the document to become a most recently changed object, wherein the first pre-specified color is associated with a most recently changed object and the second color is associated with the object that was previously the most recently changed object.

19. The computer device of claim 15, said utility further comprising program instructions for:
in response to saving changes to the document, including the time date-stamp and the color code associated with the changes to the object in a saved version of the document;
in response to closing the document after recording one or more changes to objects within the document, including the time date-stamp and the color code associated with the changes in the saved version of the document; and
subsequently re-opening and displaying a last saved version of the document with previous changes indicated via the time date-stamp and the color code, respectively indicating when the previous changes were made and which changes were most recent.
